(19) United States
(12) Patent Application Publication
(10) Pub. No.: US 2025/0282088 A1
(43) Pub. Date: Sep. 11, 2025

(54) CENTRAL AIR EXTRACTION TYPE PIPE EXTRUSION MOLD RUNNER AND DOUBLE-CHANNEL AIR EXTRACTION MOLD

(71) Applicant: NINGBO FANGLI TECHNOLOGY CO., LTD, Ningbo (CN)

(72) Inventors: Li WANG, Ningbo (CN); Jianxin WU, Ningbo (CN)

(21) Appl. No.: 18/986,284

(22) Filed: Dec. 18, 2024

(30) Foreign Application Priority Data
Mar. 7, 2024 (CN) 2024204372445
Aug. 30, 2024 (CN) 2024221187110

(51) Int. Cl. B29C 48/09; B29C 48/68; B29C 48/76; B29C 48/92; B29L 23/00

(52) U.S. Cl. CPC B29C 48/09; B29C 48/68; B29C 48/766; B29C 48/92; B29C 2948/92209; B29C 2948/924; B29C 2948/9259; B29C 2948/92914; B29L 2023/22

(57) ABSTRACT

The invention discloses a central air extraction type pipe extrusion core mold assembly runner and a two-channel air extraction core mold assembly and belongs to the technical field of plastic pipe extrusion. The central air extraction type pipe extrusion core mold assembly runner comprises a core mold assembly and an extruder screw barrel; and a splitter plate arranged between the core mold assembly and the extruder screw barrel. The two-channel air extraction core mold assembly further comprises an air inlet pipe coaxial with the central air extraction pipe. The inner wall of a pipe product is cooled by way of air extraction by the central air extraction pipe, and the inner wall of the core mold assembly is cooled by way of air extraction by the in-mold cooling channel, thereby ensuring product quality and extrusion efficiency.

### TECHNICAL FIELD

The present invention belongs to the technical field of plastic pipe extrusion and in particular relates to a central air extraction type pipe extrusion mold runner, and also relates to a double-channel air extraction mold.

### BACKGROUND

In the process of extrusion molding of a plastic pipe, the plastic raw materials are extruded and sent into a mold by an extruder, and then a molded high-temperature pipe product is produced from the mold. In order to speed up the cooling of the inner wall of the pipe product, an air extraction pipe is generally set up to extract the high-temperature gas inside the pipe product to the mold outside, but due to the limitations of the mold feeding mode, it will interfere with the layout of the air extraction pipe. At present, the common mold feeding modes are as follows:
1. End center feeding mode: In this feeding mode, the entrance of the mold is directly located in the center of the end face, the plastic melt enters the mold from the central part, and the air extraction pipe is arranged between radial runners around this central point. However, due to the limited space, the cross-sectional area of an air extraction channel is relatively small, which may lead to low air extraction efficiency, affecting the cooling speed and internal quality of the pipe product.
2. Side (right angle) feeding mode: This mode allows the feeding from one side of the mold in the form of a right angle, so that the air suction pipe can be set in the central area of the mold to achieve an effective central air extraction. However, side feeding may cause uneven flow of the melt in the mold, especially when the extrusion volume is large, pressure loss of the melt at the corner and flow rate change may lead to uneven pipe wall thickness or instable extrusion.
3. End eccentric feeding mode: the eccentric feeding mode tries to combine the advantages of central air extraction, but the position of melt entering the mold is off-center, which will also lead to the decline of the runner balance. Although it is also possible to leave a central space for the air extraction pipe after eccentric feeding, it is difficult to have compatibility for plastic raw materials with different melting indices or large flow differences because of the asymmetry of flow paths of melt.

In addition, the current large mold mainly relies on a mold temperature machine for mold temperature control, causing the problems of high energy consumption and high cost problems. A small mold only relies on a small channel for air extraction and cooling, resulting in the inability to stabilize the mold temperature, affecting product quality and extrusion efficiency.

### SUMMARY

In view of the above problems existing in the prior art, the present invention provides a central air extraction type pipe extrusion mold runner and a double-channel air extraction mold that can perform air extraction cooling on the inner wall of a pipe and the inner wall of the mold.

The present invention can be implemented by the following technical solutions:
A central air extraction type pipe extrusion mold runner, comprising
a core mold assembly and an extruder screw barrel; and
a splitter plate arranged between the core mold assembly and the extruder screw barrel, the splitter plate and the extruder screw barrel being connected by a first connector, the splitter plate and the core mold assembly being connected by second connectors, wherein
a central air extraction pipe is mounted on the core mold assembly along a central axis of the core mold assembly, a plurality of second connectors are provided and arranged around the central air extraction pipe, and a plastic melt extruded by the extruder screw barrel enters the core mold assembly along the second connectors after being split by the splitter plate.

As a further improvement of the present invention, the extruder screw barrel is supported by a bracket so that the extruder screw barrel and the core mold assembly are located on the same central axis.

As a further improvement of the present invention, the splitter plate is internally provided with a plurality of evenly distributed runners.

As a further improvement of the present invention, the number of runners is the same as the number of second connectors, and the runners are connected with the second connectors one to one.

As a further improvement of the present invention, the runners share the same feed port, and the feed port is connected with the extruder screw barrel by the first connector.

As a further improvement of the present invention, the central air extraction pipe extends from an end of the core mold assembly and is bent, and the bent central air extraction pipe passes between two adjacent second connectors.

Also provided is a two-channel air extraction mold having the central air extraction pipe extrusion mold runner, further comprising:
an air inlet pipe coaxial with the central air extraction pipe, a distance being set between an inner wall of the air inlet pipe and an outer wall of the central air extraction pipe and an air inlet channel being formed, an in-mold cooling channel being formed between an outer wall of the air inlet pipe and an inner wall of the core mold assembly, the air inlet channel being connected with the in-mold cooling channel to extract heat out of the core mold assembly to cool the inner wall of the core mold assembly.

As a further improvement of the present invention, a first end plate is arranged on a cross section of a feeding end of the core mold assembly, and the first end plate abuts against the outer wall of the inlet air pipe.

As a further improvement of the present invention, the two-channel air extraction mold further comprises an annular air extraction pipe which is mounted on the first end plate and connected to an external variable-frequency suction ventilator, and an outlet end of the in-mold cooling channel is connected with the annular air extraction pipe.

As a further improvement of the present invention, a plurality of annular air extraction pipes may be provided and distributed evenly, and the annular air extraction pipes are conjoined and connected to the external variable-frequency suction ventilator.

As a further improvement of the present invention, the two-channel air extraction mold further comprises a second end plate which is arranged on a cross section of a discharge end of the core mold assembly or on an annular space close to the inner side of the discharge end of the core mold assembly, and the second end plate abuts against the outer wall of the central air extraction pipe.

As a further improvement of the present invention, a distance is set between an air outlet end of the air inlet pipe and the second end plate and a ventilation gap is formed, and the air inlet pipe is connected with the in-mold cooling channel by the ventilation gap.

As a further improvement of the present invention, the inner wall of the core mold assembly is provided with a temperature sensor, and a control system controls the motor speed of the external variable-frequency suction ventilator according to a temperature detected by the temperature sensor to adjust an air volume.

As a further improvement of the present invention, a deflector plate is mounted on the air inlet end of the central air extraction pipe, a deflector channel is arranged in the deflector plate, and an air inlet end of the deflector channel extends to a position close to the inner wall of the pipe product.

Compared with the prior art, the present invention has the following beneficial effects:
1. The runner layout of the mold ensures the realization of the central air extraction function, achieves the uniform filling of melt plastics in the mold, optimizes the extrusion molding process, and helps to improve product quality and production efficiency.
2. Due to the arrangement of the splitter plate and the second connectors, the air extraction pipe can be arranged on the central axis of the mold to achieve the purpose of central air extraction, expand the area of the air extraction channel and improving the cooling effect on the inner wall of the pipe product, thereby improving the product quality of the final plastic pipe.
3. A plurality of second connectors are arranged around the air extraction pipe, after the plastic melt is extruded from the extruder screw barrel, the plastic melt reaches the splitter plate and is split effectively and evenly by the plurality of evenly distributed runners inside the splitter plate. After the melt is split evenly, the splitting design allows the melt to flow smoothly and evenly into each part of the mold along the second connectors connected with the runners. In this way, the problem of uneven flow in traditional runner design, which leads to the inconsistent pipe wall thickness, can be solved and the quality and consistency of the pipe product in the molding process are ensured.
4. A multi-channel structure is arranged in a balanced manner in the limited space of the pipe extrusion mold, the inner wall of the pipe product can be cooled by way of air extraction by the central air extraction pipe, and the inner wall of the core mold assembly can be cooled by way of air extraction by the air inlet pipe and the in-mold cooling channel, thereby better ensuring the product quality and extrusion efficiency.
5. The central air extraction pipe and the air inlet pipe are independent of each other, and are connected to the external central air extraction fan and the variable-frequency suction ventilator respectively, so as to achieve independent cooling control for the inner wall of the pipe product and the inner wall of the core mold assembly.
6. By using the air extraction cooling control for the core mold assembly instead of mold temperature control by a mold temperature machine, energy consumption and cost are reduced significantly.
7. The deflector plate is mounted on the air inlet end of the central air extraction pipe, the deflector channel is arranged in the deflector plate, and the air inlet end of the deflector channel extends to a position close to the inner wall of the pipe product. Due to the arrangement of the deflector plate, the hot air in the pipe product can flow along the inner wall of the pipe product and be sucked into the deflector channel, and finally extracted to the outside along the central air extraction pipe, thus improving the cooling effect on the inner wall of the pipe product.

### BRIEF DESCRIPTION OF THE DRAWINGS

FIG. 1 is a structural diagram of a central air extraction type plastic pipe extrusion mold runner according to the present invention;

FIG. 2 is section view of FIG. 1 of the invention taken along A-A;

FIG. 3 is a section view of FIG. 1 of the invention taken along B-B; and

FIG. 4 is a section view of A double-channel air extraction mold according to the present invention.

In the figures, 100. mold; 110. extruder screw barrel; 120. splitter plate; 121. runner; 122, feed port; 130. first connector; 140. second connector; 150. central air extraction pipe; 160. bracket;

170. air inlet pipe; 171. air inlet channel; 172. in-mold cooling channel; 173. ventilation gap; 180. first end plate; 190. circular air extraction pipe; 200. second end plate; 210. deflector plate; 211. deflector channel.

### DETAILED DESCRIPTION OF THE EMBODIMENTS

The following are specific embodiments of the invention to further describe the technical solution of the invention in conjunction with the accompanying drawings, but the invention is not limited to these embodiments.

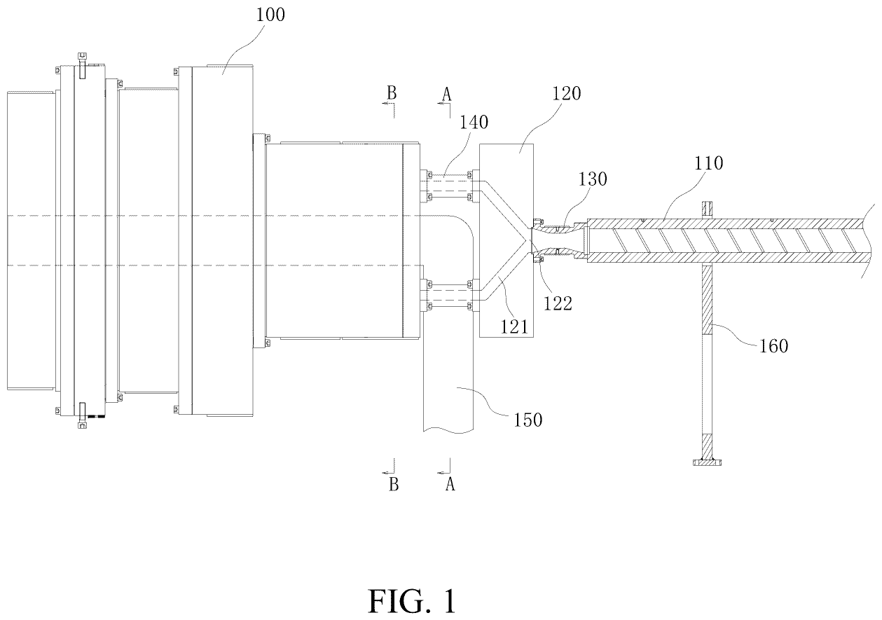

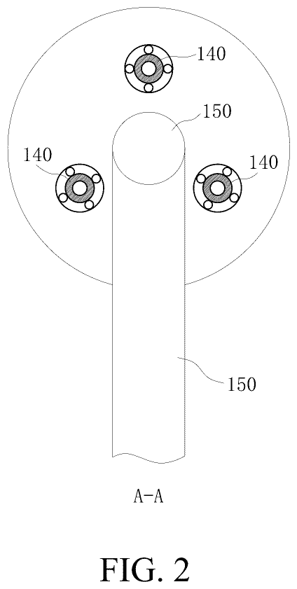

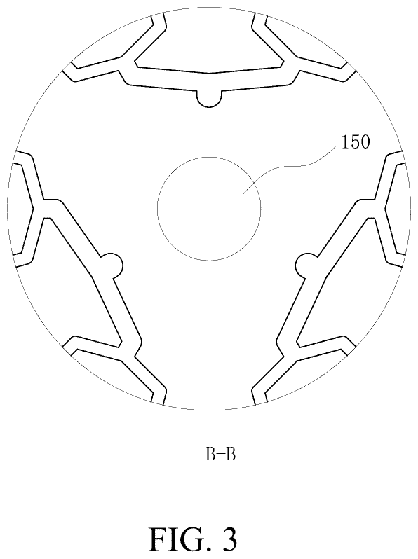

As shown in FIGS. 1-3, the present invention provides a central air extraction type pipe extrusion mold runner, comprising:
a core mold assembly 100 and an extruder screw barrel 110; and
a splitter plate 120, arranged between the core mold assembly 100 and the extruder screw barrel 110, the splitter plate 120 and the extruder screw barrel 110 being connected by a first connector 130, the splitter plate 120 and the core mold assembly 100 being connected by second connectors 140, wherein
a central air extraction pipe 150 is mounted on the core mold assembly 100 along a central axis of the core mold assembly 100, a plurality of second connectors 140 are provided and arranged around the central air extraction pipe 150, and a plastic melt extruded by the extruder screw barrel 110 flows through the second connectors 140 and into the core mold assembly 100 after being split by the splitter plate 120.

It is worth mentioning here that due to the arrangement of the splitter plate 120 and the second connectors 140, the central air extraction pipe 150 can be arranged on the central axis of the core mold assembly 100 to achieve the purpose of central air extraction, expand the area of the air extraction channel, and improve the cooling effect on the inner wall of the pipe product, thereby improving the product quality of the final plastic pipe.

Moreover, the feeding mode of the core mold assembly 100 is multi-point end feeding. A plurality of second connectors 140 are arranged around the central air extraction pipe 150. After the plastic melt is extruded from the extruder screw barrel 100, the plastic melt reaches the splitter plate 120 and is split effectively and evenly by the plurality of evenly distributed runners 121 inside the splitter plate 120. After the melt is split evenly, the splitting design allows the melt to flow smoothly and evenly into runners in the core mold assembly 100 along the second connectors connected with the runners 121. In this way, the possible problems such as uneven flow, inconsistent pipe wall thickness and difficult molding are effectively solved.

In general, the runner layout of the mold in the present invention ensures the realization of the central air extraction function, achieves the uniform filling of melt plastics in the core mold assembly 100, optimizes the extrusion molding process, and helps to improve the quality and production efficiency of pipe products.

Preferably, the extruder screw barrel 110 is supported by a bracket 160 so that the extruder screw barrel 110 and the core mold assembly 100 are located on the same central axis, thereby improving the system rigidity.

Preferably, the splitter plate 120 is internally provided with a plurality of evenly distributed runners 121, and the number of runners 121 is the same as the number of second connectors 140, and the runners 121 are connected with the second connectors 140 one to one. In this way, the melt output from the extruder screw barrel 110 can be reasonably distributed to different areas of the core mold assembly 100 by the splitter plate 120, thereby effectively avoiding the problem of uneven wall thickness caused by the imbalance of the runners 121.

Preferably, the runners 121 share the same feed port 122, and the feed port 122 is connected with the extruder screw barrel 110 by the first connector 130. The plastic melt extruded by the extruder screw barrel 110 flows into the feed port 122 of the splitter plate 120 through the first connector 130, then is evenly distributed into the runners 121, and then flows into the runners in the core mold assembly 100 through the second connectors 140.

Preferably, the central air extraction pipe 150 extends from an end of the core mold assembly 100 and is bent so that the central air extraction pipe 150 can pass between the two adjacent second connectors 140, thereby ensuring the air extraction efficiency and also achieving the balanced runner system design of the entire core mold assembly 100.

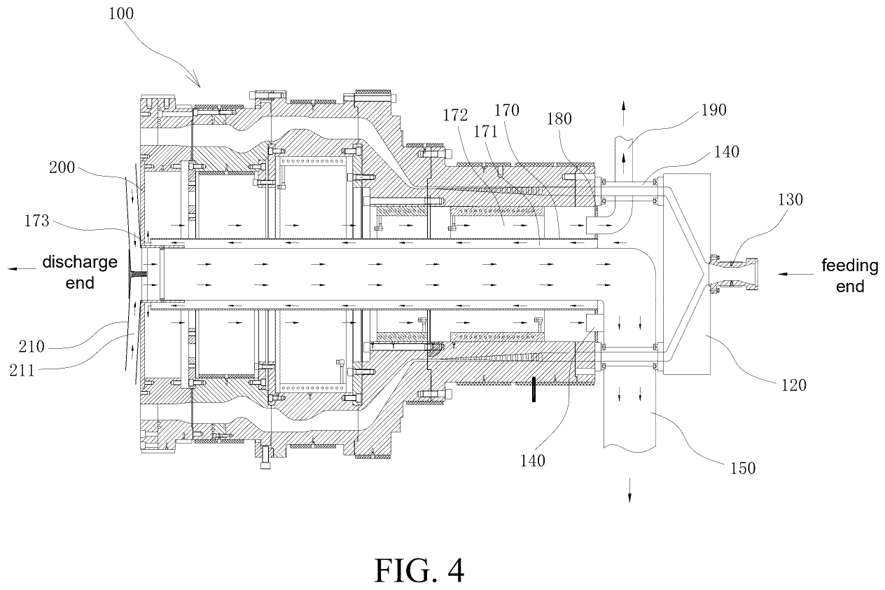

As shown in FIG. 4, the present invention also provides a two-channel air extraction mold having the central air extraction pipe extrusion mold runner described above, further comprising:
an air inlet pipe 170 coaxial with the central air extraction pipe 150, a distance being set between an inner wall of the air inlet pipe 170 and an outer wall of the central air extraction pipe 150 and an air inlet channel 171 being formed, an in-mold cooling channel 172 being formed between an outer wall of the air inlet pipe 170 and an inner wall of the core mold assembly 100, the air inlet channel 171 being connected with the in-mold cooling channel 172 to extract heat out of the core mold assembly 100 to cool the inner wall of the core mold assembly 100.

That is, in the pipe extrusion mold of the present invention, a multi-channel structure is arranged in a balanced manner in the limited space of the mold, the inner wall of the pipe product can be cooled by way of air extraction by the central air extraction pipe 150, and the inner wall of the core mold assembly 100 can be cooled by way of air extraction by the air inlet pipe 170 and the in-mold cooling channel 172, thereby better ensuring product quality and extrusion efficiency.

In addition, the central air extraction pipe 150 and the air inlet pipe 170 are independent of each other, and are connected to an external central air extraction fan and variable-frequency suction ventilator respectively, so as to achieve independent cooling control for the inner wall of the pipe product and the inner wall of the core mold assembly 100.

Moreover, by using the air extraction cooling control for the core mold assembly 100 instead of mold temperature control by a mold temperature machine, energy consumption and cost are reduced significantly.

Preferably, a first end plate 180 is arranged on a cross section of a feeding end of the core mold assembly 100, and the first end plate 180 abuts against the outer wall of the inlet air pipe 170 to locate and fix the air inlet pipe 170.

Further, the two-channel air extraction mold further comprises an annular air extraction pipe 190 which is mounted on the first end plate 180 and connected to an external variable-frequency suction ventilator, and an outlet end of the in-mold cooling channel 172 is connected with the annular air extraction pipe 190, wherein the inner wall of the core mold assembly 100 is provided with a temperature sensor, and a control system controls the motor speed of the external variable-frequency suction ventilator according to a temperature detected by the temperature sensor to adjust the air volume of the variable-frequency suction ventilator.

Specifically, when the temperature sensor detects that the core mold temperature is higher than a set value, the control system controls the variable-frequency suction ventilator to start, and the normal-temperature air enters the in-mold cooling channel 172 through the air inlet channel 171, absorbs heat from the inner wall of the core mold assembly 100, and the hot air is discharged through the annular air extraction pipe 190, thus cooling the inner wall of the core mold assembly 100.

The speed (i.e., the suction air volume) of the variable-frequency suction ventilator can be automatically adjusted according to the temperature detected by the temperature sensor, so as to realize the stable control of the temperature in the mold and ensure the extrusion quality and extrusion efficiency of the pipe product.

Preferably, a plurality of annular air extraction pipes 190 may be provided and distributed evenly, and the annular air extraction pipes 190 are conjoined and connected to the external variable-frequency suction ventilator, thereby ensuring the uniform air extraction cooling effect in the mold and avoiding insufficient local cooling.

Preferably, the two-channel air extraction mold further comprises a second end plate 200 which is arranged on a cross section of a discharge end of the core mold assembly 100 or on an annular space close to the inner side of the discharge end of the core mold assembly 100, and the second end plate 200 abuts against the outer wall of the central air extraction pipe 150 to locate and fix the central air extraction pipe 150.

Preferably, a distance is set between an air outlet end of the air inlet pipe 170 and the second end plate 200 and a ventilation gap 173 is formed, and the air inlet pipe 170 is connected with the in-mold cooling channel 172 by the ventilation gap 173. Because the ventilation gap 173 is arranged at the position where the outlet end of the inlet duct 170 is located, the normal-temperature air can flow from the discharge end of the core mold assembly 100 to the feeding end to achieve uniform cooling in the mold.

Preferably, a deflector plate 210 is mounted on an air inlet end of the central air extraction pipe 150, a deflector channel 211 is arranged in the deflector plate 210, and an air inlet end of the deflector channel 211 extends to a position close to the inner wall of the pipe product. Due to the arrangement of the deflector plate 210, the hot air in the pipe product can flow along the inner wall of the pipe product and be sucked into the deflector channel 211 and finally extracted to the outside along the central air extraction pipe 150, thus improving the cooling effect on the inner wall of the pipe product.

The technical means disclosed by the solutions of the invention is not only limited to the technical means disclosed above, but also includes the technical solutions composed of any combination of the technical features described above. The above is only preferred embodiments of the invention. It should be pointed out that for those of ordinary skill in the art, some improvements and modifications can be made without departing from the principles of the invention. These improvements and modifications should also be regarded as the scope of the invention.

It should be noted that all directional indications in the embodiments of the invention (such as upper, lower, left, right, front, and back) are only used to explain the relative position relationship, movement, etc. between the components under a certain posture (as shown in the accompanying drawings). If the specific posture changes, the directional indications will also change accordingly.

In addition, in the invention, the descriptions such as “first”, “second”, and “one”, are only used for descriptive purposes, and should not be construed as indicating or implying their relative importance or implicitly indicating the number of technical features indicated. Therefore, the features defined as “first” and “second” may explicitly or implicitly include at least one of the features. In the description of the invention, the meaning of “multiple” is at least two, such as two and three, unless otherwise clearly and specifically defined.

As used herein, unless otherwise clearly specified and defined, the terms “connect”, “fix”, etc. should be understood in a broad sense. For example, “fix” may be a fixed connection, a detachable connection, or an integral connection; it may be a mechanical connection or an electrical connection; it may be a direct connection or an indirect connection by means of an intermediate medium. it may be the internal connection of two elements or the interaction relationship between two elements, unless otherwise clearly defined. For those of ordinary skill in the art, the specific meanings of the above terms in the invention can be understood according to specific circumstances.

In addition, the technical solutions of the various embodiments of the invention can be combined, but it must be based on the fact that those of ordinary skill in the art can implement it. When the combination of technical solutions is contradictory or cannot be achieved, it should be considered that such a combination of technical solutions does not exist and is not within the scope of the invention.

What is claimed is:

1. A central air extraction type pipe extrusion mold runner, characterized by, comprising:
a core mold assembly and an extruder screw barrel; and
a splitter plate arranged between the core mold assembly and the extruder screw barrel, the splitter plate and the extruder screw barrel being connected by a first connector, the splitter plate and the core mold assembly being connected by second connectors, wherein
a central air extraction pipe is mounted on the core mold assembly along a central axis of the core mold assembly, a plurality of second connectors are provided and arranged around the central air extraction pipe, and a plastic melt extruded by the extruder screw barrel enters the core mold assembly along the second connectors after being split by the splitter plate.

2. The central air extraction type pipe extrusion mold runner according to claim 1, characterized in that, the extruder screw barrel is supported by a bracket so that the extruder screw barrel and the core mold assembly are located on the same central axis.

3. The central air extraction type pipe extrusion mold runner according to claim 1, characterized in that, the splitter plate is internally provided with a plurality of evenly distributed runners.

4. The central air extraction type pipe extrusion mold runner according to claim 3, characterized in that, the number of runners is the same as the number of second connectors, and the runners are connected with the second connectors one to one.

5. The central air extraction type pipe extrusion mold runner according to claim 3, characterized in that, the runners share the same feed port, and the feed port is connected with the extruder screw barrel by the first connector.

6. The central air extraction type pipe extrusion mold runner according to claim 1, characterized in that, the central air extraction pipe extends from an end of the core mold assembly and is bent, and the bent central air extraction pipe passes between two adjacent second connectors.

7. A two-channel air extraction mold having the central air extraction pipe extrusion mold runner according to claim 1, characterized by, further comprising:
an air inlet pipe coaxial with the central air extraction pipe, a distance being set between an inner wall of the air inlet pipe and an outer wall of the central air extraction pipe and an air inlet channel being formed, an in-mold cooling channel being formed between an outer wall of the air inlet pipe and an inner wall of the core mold assembly, the air inlet channel being connected with the in-mold cooling channel to extract heat out of the core mold assembly to cool the inner wall of the core mold assembly.

8. The two-channel air extraction mold according to claim 7, characterized in that, a first end plate is arranged on a cross section of a feeding end of the core mold assembly, and the first end plate abuts against the outer wall of the inlet air pipe.

9. The two-channel air extraction mold according to claim 8, characterized by, further comprising an annular air extraction pipe which is mounted on the first end plate and connected to an external variable-frequency suction ventilator, an outlet end of the in-mold cooling channel being connected with the annular air extraction pipe.

10. The two-channel air extraction mold according to claim 9, characterized in that, a plurality of annular air extraction pipes are provided and distributed evenly, and the annular air extraction pipes are conjoined and connected to the external variable-frequency suction ventilator.

11. The two-channel air extraction mold according to claim 7, characterized by, further comprising a second end plate which is arranged on a cross section of a discharge end of the core mold assembly or on an annular space close to the inner side of the discharge end of the core mold assembly, the second end plate abutting against the outer wall of the central air extraction pipe.

12. The two-channel air extraction mold according to claim 11, characterized in that, a distance is set between an air outlet end of the air inlet pipe and the second end plate and a ventilation gap is formed, and the air inlet pipe is connected with the in-mold cooling channel by the ventilation gap.

13. The two-channel air extraction mold according to claim 7, characterized in that, the inner wall of the core mold assembly is provided with a temperature sensor, and a control system controls the motor speed of the external variable-frequency suction ventilator according to a temperature detected by the temperature sensor to adjust an air volume.

14. The two-channel air extraction mold according to claim 7, characterized in that, a deflector plate is mounted on the air inlet end of the central air extraction pipe, a deflector channel is arranged in the deflector plate, and an air inlet end of the deflector channel extends to a position close to the inner wall of the pipe product.
